(19) United States
(12) Patent Application Publication
(10) Pub. No.: US 2008/0063745 A1
(43) Pub. Date: Mar. 13, 2008

(54) Thermowelding Station for Producing Thermoformable and Thermoweldable Containers

(76) Inventor: Massimiliano Parini, Albertone di Cento (IT)

Correspondence Address: FLYNN THIEL BOUTELL & TANIS, P.C., 2026 RAMBLING ROAD, KALAMAZOO, MI, 49008-1631, US

(21) Appl. No.: 11/659,605

(22) PCT Filed: Aug. 4, 2005
(86) PCT No.: PCT/IB05/02612

§ 371 Date: Feb. 6, 2007

(30) Foreign Application Priority Data
Aug. 6, 2004 (IT) BO2004A000513

(51) Int. Cl. B29C 49/00

(52) U.S. Cl. 425/547; 264/572

(57) ABSTRACT

A thermowelding station for producing thermoformable and thermoweldable containers of the type comprising welding means for thermowelding predetermined portions of two thermoweldable material strips, thereby defining the contours of a central zone and at least a mouth zone which opens outwards and communicates with the central zone. The thermowelding station further comprises means for forming the mouth zone, which means are selectively movable with respect to the welding means.

The present invention relates to the field of equipment for producing containers of thermoformable and thermoweldable plastics material.

The invention has been developed with particular regard to a thermowelding station having welding means for thermowelding predetermined portions of two strips of thermoweldable material, thereby defining the contours of a central zone and at least a mouth zone which opens outwards and communicates with the central zone.

Equipment of known type for producing thermoformable containers generally comprises one or more thermowelding and thermoforming stations. As indicated above, in the thermowelding station the material strips are heated and welded along the contour which is defined by the shape which the finished container will have to take up, whilst in the forming station the material strips are formed by means of a forming fluid being injected into the central zone which is thereby deformed in order to define a recess for accommodating the product. The forming station typically comprises two moulds and a plurality of nozzles, fixed or movable nozzles, able to inject the forming fluid inside the main recess through the mouth zone. The nozzles are inserted between the material strips, at the mouth zone, and the moulds are closed in a sealing manner on the two material strips and on the nozzles, deforming the strips in the region of the mouth zone and thereby defining a mouth of the container.

The containers welded and formed in that manner are then directed to one or more filling stations, in which a product in a flowable or fluid form is introduced into the accommodating recess through the mouth which has previously been formed. Subsequently, the end of the mouth is closed by means of welding and the containers are directed to one or more cutting stations in order to separate them from each other.

One of the main disadvantages which is encountered with this type of equipment is that, during the welding step, the material strips near the mouth zone also tend to become bonded to each other owing to the heat emitted by the moulds and the thermowelding operation. In that manner, in the thermoforming station, the insertion of the nozzles in the mouth zone is often complex and poorly effective. For the purpose of preventing that disadvantage, some thermowelding and forming stations of known type comprise a separator element so as to keep the material strips separate in the region of the mouth zone. For this purpose, reference is made to the content of documents EP 0 692 428, WO94/08852 and EP 0 479 152, wherein the separator element is cuneiform and extends over the entire width of the thermowelding station.

However, the solutions of known type also have some disadvantages. The separator elements have large dimensions and tend to leave unused a large portion of the material strips. Since a request which is particularly heard in the field is to limit the use of material for producing the containers so as to reduce as much as possible the waste of material not used, the solutions of known type are not very advantageous in that sense.

Generally, the heat and prolonged use tend to damage the surface of the separator elements and to act in such a manner that the material strips tend to remain bonded to them, tearing and spoiling the material portions which are necessary for forming, in the subsequent station, the mouth of the container. Furthermore, even if they are kept separate, the material strips are still subjected to abrupt thermal shocks between one station and the next and tend to become damaged, losing many of the physical characteristics thereof, and in particular resilience. This makes the forming of the mouth of the container in the forming station less precise and, consequently, the tightness of the container itself.

The object of the present invention is to overcome the above-indicated disadvantages by prearranging a thermowelding station for forming containers which are produced from thermoformable and thermoweldable plastics material of the type indicated above, which allows the mouth of the container to be readily obtained and, at the same time, providing good finishing and tightness of that mouth. Another object of the invention is to provide a thermowelding station of the above-indicated type which can readily be installed in existing installations without the need for substantial structural modifications thereto.

Another object of the invention is to provide a method for producing containers from thermoformable and thermoweldable plastics material, which containers have the above-indicated features, and allowing material to be saved with respect to the known methods for producing containers.

In order to achieve the above-indicated objects, the invention relates to a thermowelding station as defined in the main claim below. The invention also relates to a method for producing a container for a product, having the features indicated in the claims below.

The means for forming the mouth of the container in accordance with the present invention preferably comprise means for injecting a preforming fluid. The end of the nozzles opening inside the central zone of the container defined by the welding lines is connected to a system for injecting fluid which allows the central zone to be preformed, making the action of welding the contours thereof more effective.

Further features and advantages will become clear from the following detailed description of a preferred embodiment given with reference to the appended Figures purely by way of non-limiting example, in which:

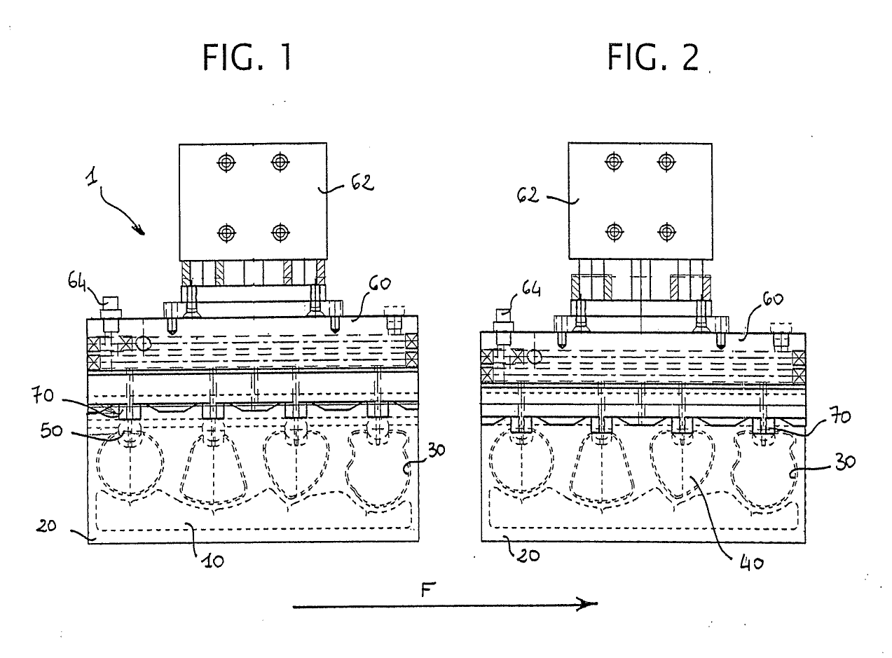

FIG. 1 is a front view of a thermowelding station of the present invention, in which the movable collector is in the raised rest position;

FIG. 2 is a front view of a thermowelding station of the present invention, in which the movable collector is in the lowered position;

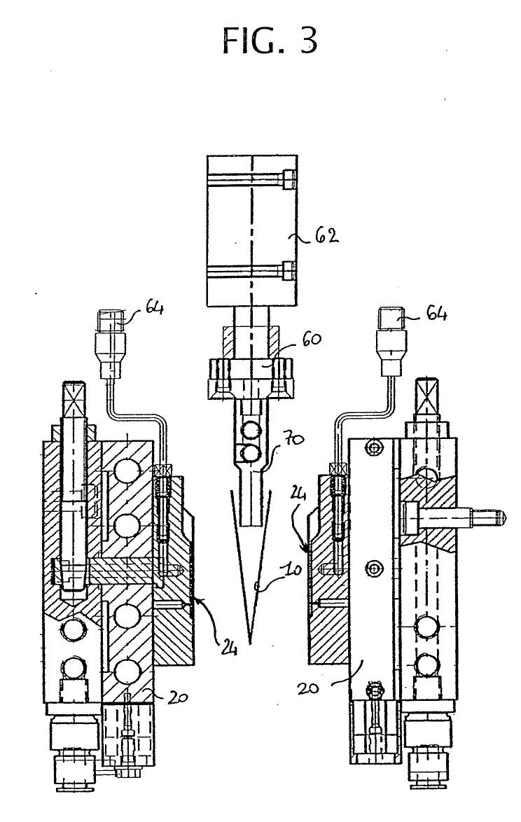

FIG. 3 is a sectional side view of a thermowelding station of the present invention, in which the moulds are in the open position; and

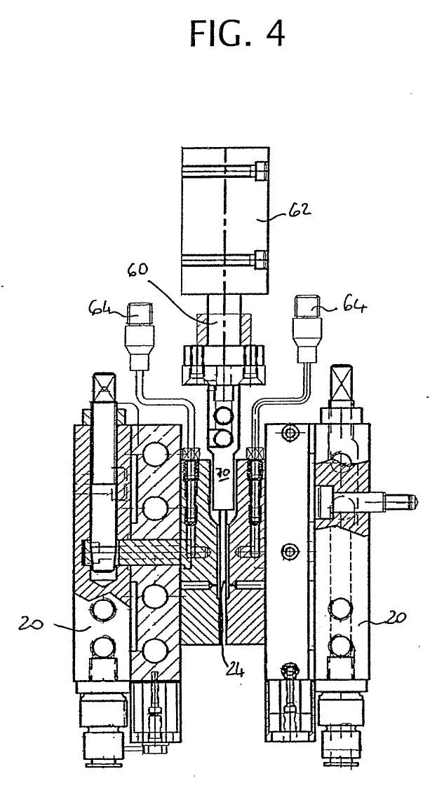

FIG. 4 is a sectional side view of a thermowelding station of the present invention, in which the moulds are in the closed position.

With reference now to the Figures, a piece of equipment for forming containers comprises supply means for supplying thermoformable and thermoweldable plastics material to a thermowelding station 1 in a preferential direction F. The material strips 10 can be formed by a single web which is folded along the centre axis thereof, or by two separate webs of material which are arranged side by side. The strips can be composed of continuous material webs which are, for example, from a roll of material, or by webs having finished dimensions of a predetermined length.

The thermowelding station 1 according to the present invention comprises a main frame, to which there are connected movable welding means, for example, but in a non-limiting manner, two welding elements, which are arranged so as to be opposite each other and able to move towards and away from each other in accordance with a direction transverse to the advance direction of the material to be thermowelded. The welding elements, for example, two welding moulds 20, each comprise an internal surface which, during use, faces the material strips and on which thermowelding surfaces 24 of the known type are formed in order to weld the two material strips along predetermined welding lines 30, and in order to define a central zone 40 and a mouth zone 50 of the container.

The thermowelding station further comprises means for forming the mouth of the container, which are particularly suitable for forming and/or preforming the mouth of the container during a welding step. The forming means can comprise, for example, but in a non-limiting manner, forming nozzles 70, which are arranged beside and spaced-apart from each other in accordance with predetermined intervals. The nozzles 70 are of substantially elongate form in a preferential direction and are arranged in accordance with a direction substantially orthogonal relative to the direction of advance F of the thermoformable material. The nozzles 70 comprise, at one end thereof, an injection hole 72 and are connected to a forming device, for example, a device for injecting a pressurized forming fluid, which is preferably heated, so as to impart a shape to the material strips which are closed in the moulds 20. In particular, the forming means comprise inlet means 64, for example, an inlet valve or socket, for a preforming fluid which is in fluid connection with the forming nozzles 70.

Furthermore, the forming nozzles 70 are engaged with movement means, for example, but in a non-limiting manner, a collector 60, which is connected to actuation means 62 which allow, during use, vertical movement of the nozzles 70 towards and away from the material strips 10.

When in use, the material strips 10 are caused to advance inside the welding station by a predetermined portion which is sufficient for welding a predetermined number of containers. In that step, the forming nozzles 70 are located in a raised rest position so that the injection holes 72 are external to the material strips 10. As illustrated in FIG. 3, before the material strips 10 are closed, the collector 60 is lowered, with the forming nozzles 70 being moved towards the material strips and inserted near the mouth zone 50, in such a manner that the injection holes 72 are located in the region of the mouth zones 50 of the material strips.

Then, as illustrated in FIG. 4, the two moulds 20 are closed, clamping both the welding lines 30 between the thermowelding surfaces 24 and the portions of strips of the mouth zone 50 between the nozzles 70 and the thermowelding surfaces 24 themselves. The nozzles 70, being sealed on the moulds 20, allow the mouths of the containers to be formed, whilst the thermowelding surfaces 24 define the contours of the main recess of the container. The preforming fluid is injected between the material strips 10 near the central zone 40 and allows the two strips in that zone to be partially moved apart, preventing mutual adhesion, keeping them at a high temperature and causing them to better adhere to the thermowelding walls. This consequently also makes the action of welding the contours of the container 30 more effective at the side of the thermowelding surfaces 24.

Once the welding step is complete, the two moulds 20 are opened, being moved away from the material strips and, at the same time, the nozzles 70 are lifted, returning to a rest position in which the injection holes 72 are external to the material strips 10. The material strips are moved towards the subsequent forming station, where further nozzles are readily inserted in the mouths of the containers which have recently been formed and distinctly defined. At the same time, further material strips are advanced inside the welding station for another welding and preforming step.

It is advantageous to set out that the presence of the elements for forming the mouth prevents the use of means for separating the material strips. In fact, according to that configuration, the portions of strips in the region of the mouth zones are directly formed as mouths of the containers, and the remaining portions of material strips can be welded to each other. Furthermore, by forming the mouths of the containers directly during the step for welding the contours thereof, it is possible to reduce the portion of the material strips which is not normally welded in order to allow the introduction of the forming nozzles in the subsequent station.

Another advantage of the present invention is constituted in that the material strips which arrive at the thermowelding station have a relatively low temperature, for example, corresponding to ambient temperature. Since the thermowelding moulds are closed on the material strips when the forming elements are already introduced into the mouth zones, the preforming of the mouths is brought about at a temperature which allows them to obtain optimum finishing, with well-defined edges and integral surfaces. These features bring further advantages in the subsequent forming station, but, above all in the filling stations and closing stations for the containers because the sealing of the containers formed in this manner is substantially promoted.

Naturally, the principle of the invention remaining the same, the forms of embodiment and details of construction may be varied widely with respect to those described and illustrated, without thereby departing from the scope of the invention.

1. A thermowelding station for producing thermoformable and thermoweldable containers of the type comprising welding means (20) for thermowelding predetermined portions of two thermoweldable material strips (10), thereby defining the contours of a central zone (40) and at least a mouth zone (50) which opens outwards and communicates with the central zone (40), characterized in that the thermowelding station (1) further comprises means (70) for forming said mouth zone (50), the forming means being selectively movable with respect to the welding means (20).

2. A thermowelding station according to claim 1, characterized in that forming means comprise a plurality of forming nozzles (70) which are arranged side by side.

3. A thermowelding station according to claim 2, characterized in that the forming nozzles (70) are connected to actuation means (62) which allow, during use, movement of the nozzles (70) towards and away from said welding means (20).

4. A thermowelding station according to claim 3, characterized in that the forming nozzles (70) are connected to a device for injecting a pressurized forming fluid.

5. A method for producing thermoformable and thermoweldable containers, comprising the steps of prearranging thermoformable and thermoweldable material strips (10), prearranging a thermowelding station (1) which comprises welding means (20), moving the material strips (10) towards the thermowelding station (1) in a preferential direction (F), closing the welding means (20) on the material strips (10) so as to define the contours of a central zone (40) and of at least a mouth zone (50) which opens outwards and communicates with the central zone of a container, characterized in that it further comprises the steps of approaching forming means (70) towards the material strips (10) and inserting said forming means (70) near the mouth zone (50) between the material strips (10) and preforming a mouth of the container.

6. A method according to claim 5, characterized in that it further comprises the step of injecting a forming fluid by means of the forming means (70) between the material strips near the central zone (40) in order to move apart the material strips (10) and to preform a mouth of the container.
